(19) United States
(12) Patent Application Publication
(10) Pub. No.: US 2026/0296133 A1
(43) Pub. Date: Oct. 1, 2026

(54) HVAC SYSTEM FOR A VEHICLE

(71) Applicants: HYUNDAI MOTOR COMPANY, Seoul (KR); KIA CORPORATION, Seoul (KR); HANON SYSTEMS, Daejeon (KR)

(72) Inventors: Kwang Ok Han, Hwaseong-si (KR); Hyo Geun Oh, Hwaseong-si (KR); Su Yeon Kang, Hwaseong-si (KR); Jae Chun Ryu, Daejeon (KR); Jeong Sik Shin, Daejeon (KR); Tae Yong Park, Daejeon (KR)

(73) Assignees: HYUNDAI MOTOR COMPANY, Seoul (KR); KIA CORPORATION, Seoul (KR); HANON SYSTEMS, Daejeon (KR)

(21) Appl. No.: 19/313,254

(22) Filed: Aug. 28, 2025

(30) Foreign Application Priority Data
Mar. 25, 2025 (KR) 10-2025-0037914

(51) Int. Cl. B60H 1/00

(52) U.S. Cl. CPC B60H 1/00514; B60H 1/00021; B60H 1/00564

(57) ABSTRACT

A heating, ventilation, and air conditioning (HVAC) system includes a system body having at least a condenser and an evaporator. The HVAC system also includes a casing surrounding the system body and having a circular or elliptical circumferential shape. The casing includes an inlet hole through which external air is introduced and an outlet hole for discharging air.

### CROSS-REFERENCE TO RELATED APPLICATION(S)

This application claims the benefit of priority to Korean Patent Application No. 10-2025-0037914 filed on Mar. 25, 2025 in the Korean Intellectual Property Office, the disclosure of which is incorporated herein by reference in its entirety.

### TECHNICAL FIELD

The present disclosure relates to a heating, ventilation, and air conditioning (HVAC) system for a vehicle, which, is configured to reduce air resistance and improve fuel efficiency or electric efficiency of the vehicle.

### BACKGROUND

An air conditioning apparatus for a vehicle, i.e., a heating, ventilation, and air conditioning (HVAC) system, may be a system for providing cooling, heating, and ventilation to an interior of the vehicle. The HVAC system may also supply external air and/or inside air to the interior of the vehicle by intaking external air or circulating inside air.

For example, the HVAC system of the vehicle may be mounted on an upper portion of the vehicle, i.e., on a roof of the vehicle, to address installation space limitations and to enable efficient use of the system. In this case, due to a size and a shape of the HVAC system, the vehicle may have degraded aerodynamic performance. In other words, an increase in air resistance may adversely affect fuel efficiency or electric efficiency of the vehicle.

To solve such an issue, a shape of the HVAC system may be formed to have a streamlined structure. For example, when a shape of a casing including an external air introduction device is simply changed to a shape having a circular cross-section, a size of the HVAC system may instead increase due to geometric factors, thus adversely affecting aerodynamics.

### SUMMARY

An aspect of the present disclosure is to provide a heating, ventilation, and air conditioning (HVAC) system for a vehicle, which has a streamlined structure and a minimized size, thereby reducing air resistance and improving fuel efficiency or electric efficiency of the vehicle.

According to an aspect of the present disclosure, a HVAC system is provided. The HVAC system includes a system body at least having a condenser and an evaporator. The HVAC system also includes a casing surrounding the system body. The casing has a circular or elliptical cross-sectional shape. The casing may include an inlet hole through which external air is introduced and an outlet hole for discharging air.

The casing may at least partially have a dome shape.

The inlet hole may be provided as a plurality of inlet holes. The outlet hole may be provided as a plurality of outlet holes and may be formed on a side surface of the casing.

The HVAC system may further include a sliding door in the casing to open and close the outlet hole or plurality of outlet holes and a driving portion in the casing to drive the sliding door.

The sliding door may include a plurality of opening portions and a plurality of closing portions, alternately formed in a circumferential direction of the sliding door.

At least one of the plurality of closing portions may have a closed area different from those of other closing portions.

The sliding door may be formed of a flexible material.

The casing may include a first cover and a second cover. The first cover may include a plurality of inlet holes formed and arranged at a predetermined interval in a circumferential direction. The second cover may include a bottom plate and a side plate connected to an edge of the bottom plate. The side plate may include a plurality of outlet holes formed and arranged at a predetermined interval.

The system body may further include a pair of external air introduction portions and a mixing chamber disposed between the pair of external air introduction portions. The mixing chamber may have one side to which the condenser is connected and another side to which the evaporator is connected. The system body may also include a pair of blowers respectively disposed downstream of the condenser and downstream of the evaporator and a plurality of air supply portions respectively connected to the blowers.

The air supply portion may include a first air supply duct, a second air supply duct branched from the first air supply duct, and an air supply door disposed between the first air supply duct and the second air supply duct. An opening of the second air supply duct may be in communication with the outlet hole or one of the plurality of the outlet holes.

The air supply portion may further include a sidewall member connecting ends of a plurality of the second air supply ducts respectively having the opening to each other. The sidewall member may include a plurality of through-holes formed at a predetermined interval in a circumferential direction of the sidewall member and disposed to be respectively in communication with the opening portions.

The HVAC system may further include a sliding door in the casing to open and close the outlet hole or the plurality of the outlet holes and may include a driving portion in the casing to drive the sliding door. The sliding door may include a plurality of opening portions and a plurality of closing portions alternately formed and may be positioned and move in a gap between the sidewall member and the side plate in the casing.

The sliding door may include a rack gear formed on an internal surface of a circumferential edge portion. The driving portion may include an actuator, a driving shaft rotatably connected to the actuator, and a pinion gear provided on the driving shaft to engage with the rack gear.

The sidewall member may include a cutout groove formed to allow the pinion gear, disposed radially inwardly, to engage with the rack gear, disposed radially outwardly.

The driving portion may further include a driving gear provided on the driving shaft, a driven gear provided on the air supply door, and a connection gear interposed between the driving gear and the driven gear to engage with the driving gear and the driven gear.

The casing may include a separator disposed between the first cover and the second cover. The separator may include a plurality of communication holes formed to pass through the separator. The communication holes may be disposed to correspond to an inlet of the external air introduction portion.

According to example embodiments of the present disclosure, an HVAC system may be formed to have a streamlined structure and a minimized size, thereby reducing air resistance and improving fuel efficiency or electric efficiency of a vehicle.

### BRIEF DESCRIPTION OF DRAWINGS

The above and other aspects, features, and advantages of the present disclosure should be more clearly understood from the following detailed description, taken in conjunction with the accompanying drawings, in which:

FIG. 1 is a perspective view of a heating, ventilation, and air conditioning (HVAC) system according to an example embodiment of the present disclosure;

FIG. 2 is a perspective view of the HVAC system of FIG. 1 with a first cover separated from a second cover;

FIG. 3 is an exploded perspective view of the HVAC system of FIG. 1;

FIG. 4 is a plan view of the HVAC system of FIG. 1 with a first cover and a separator omitted;

FIGS. 5A-5D illustrate opening and closing of a sliding door according to an operating mode of a HVAC system;

FIGS. 6A and 6B illustrate example modifications of a casing for a HVAC system; and

FIGS. 7A and 7B illustrate further example modifications of a casing for a HVAC system.

### DETAILED DESCRIPTION

As used herein, vehicles refer to various vehicles transporting a transported object such as a person, animal, or object from a starting point to a destination. Such vehicles are not limited to vehicles travelling on roads or tracks.

As used herein, the terms used in relation to direction, such as “front,” “rear,” “left,” “right,” “upper,” “lower,” and the like, are defined based on a vehicle or a body of the vehicle as a reference.

In addition, the terms such as “first,” “second,” “third,” “fourth,” and the like may be used herein to describe components. Each of the terms is not used to define an essence, order, size, position, or importance of a corresponding component but used merely to distinguish the corresponding component from other component(s).

For example, in large-sized vehicles such as buses, due to a long vehicle body and a wide interior space, a high-capacity air conditioner may be required. Such a requirement may make it difficult to install a heating, ventilation, and air conditioning (HVAC) system in the vehicle or in an engine compartment of the vehicle. In this case, at least a portion of the HVAC system may be installed on a roof of the vehicle.

Autonomous vehicles capable of sensing a surrounding environment and performing automated navigation without human intervention have been introduced. In such autonomous vehicles, a driver may not be seated in a front seat of the vehicle, or the front seat may face the rear of the vehicle. To this end, it may be necessary to increase space and convenience in an interior of the vehicle. Accordingly, installation of an HVAC system on a roof of a vehicle may be considered.

However, as described above, when the HVAC system is mounted on the roof of the vehicle, due to a size and shape of the HVAC system, the vehicle may have degraded aerodynamic performance, which may adversely affect fuel efficiency or electric efficiency of the vehicle. In addition, when a shape of a casing is simply changed to a circular cross-sectional shape, a size of the HVAC system may increase due to geometric factors.

Accordingly, the present disclosure proposes an HVAC system for a vehicle, which is configured to have a streamlined structure and a minimized size to reduce air resistance and improve fuel efficiency or electric efficiency of the vehicle.

Hereinafter, embodiments of the present disclosure are described in detail with reference to the accompanying drawings. In adding reference numerals to components of each drawing, it should be noted that the same components are indicated by the same numerals even though displayed on different drawings.

When a component, device, unit, module, element, apparatus, or the like of the present disclosure is described as having a purpose or performing an operation, function, or the like, the component, device, unit, module, element, apparatus, or the like should be considered herein as being “configured to” meet that purpose or to perform that operation or function.

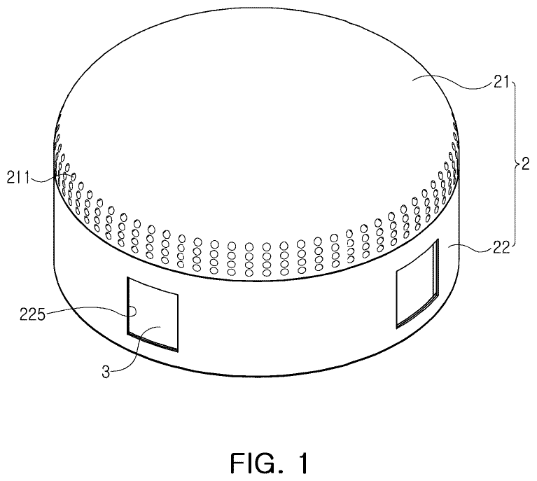

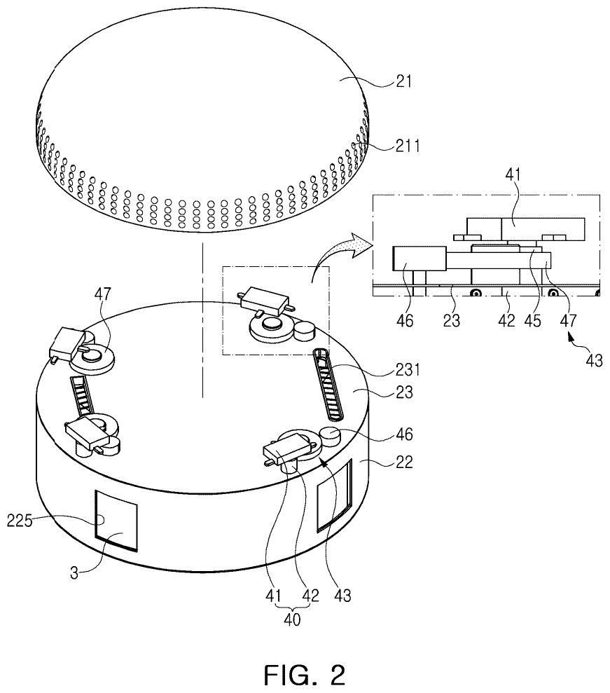

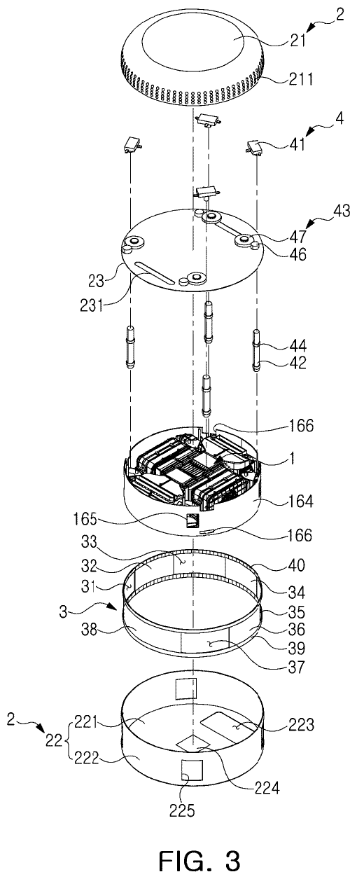

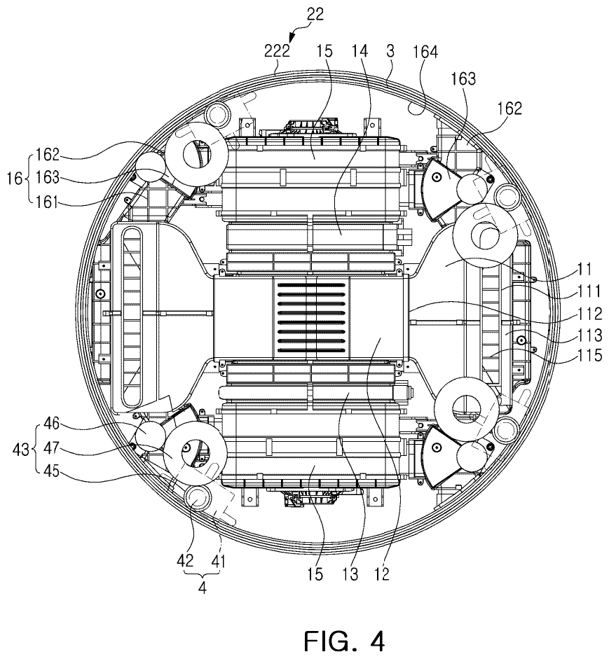

FIG. 1 is a perspective view of a HVAC system according to an example embodiment of the present disclosure. FIG. 2 is a perspective view of the HVAC system of FIG. 1 with a first cover and a second cover separated from each other. FIG. 3 is an exploded perspective view of the HVAC system of FIG. 1. FIG. 4 is a plan view of the HVAC system of FIG. 1 with a first cover and a separator omitted.

As illustrated in FIGS. 1-4, a HVAC system according to an example embodiment of the present disclosure may include a system body 1 and a casing 2. The HVAC system may be mounted on a roof of a vehicle, but the present disclosure is not limited thereto.

The system body 1 may include at least a condenser 13 and an evaporator 14. In addition, the system body 1 may further include one or a pair of external air introduction portions 11, a mixing chamber 12, and one or a pair of blowers 15. The below description describes one such air introduction portion 11 and one such blower 15 for expediency, with the understanding that each portion 11 and blower 15 may have an identical or mirror image construction.

The external air introduction portion 11 may be formed as a duct-shaped member having an internal space. The external air introduction portion 11 may be formed of a rigid material with sufficient rigidity, for example, metal or plastic, but the material is not limited.

One side of the external air introduction portion 11 in a front-to-rear direction may have an inlet 111 through which external air is introduced into an internal space thereof. The other side of the external air introduction portion 11 may have an outlet 112 provided to be in communication with the mixing chamber 12. A discharge unit (not illustrated) may be disposed on a lower portion of the external air introduction portion 11.

For example, one side of an upper portion of the external air introduction portion 11 may have an inclined surface 113. The inclined surface may have an inlet 111 having a predetermined size. An inlet grille 115 may be mounted on the inlet 111.

As described, the inlet 111 may be formed on the inclined surface 113 and may be disposed in a gently inclined manner, whereby external air may be easily introduced through the inlet 111. However, light foreign substances or rainwater may not be introduced through the inlet and may instead pass over the inlet along with an air stream flowing around the system body 1 due to the movement of the vehicle

In addition, the external air introduction portion 11 may be formed such that a width of the external air introduction portion 11 in a left and right direction gradually decreases from the one side of the external air introduction portion 11 having the inlet 111 toward the other side of the external air introduction portion 11 having the outlet 112.

The external air introduction portion 11 may include at least one filter member (not illustrated) disposed in the internal space and/or on the outlet 112. Foreign substances or moisture may be filtered by the filter member from a flow path of external air.

Through such filtering, external air that is as fresh as possible and free of foreign substances or moisture may flow into the mixing chamber 12 of the system body 1.

The discharge unit may be disposed on the lower portion of the external air introduction portion 11, such that foreign substances or moisture filtered by the filter member may be discharged externally. Foreign substances or moisture discharged to the outside of the external air introduction portion 11 may fall freely into the inside of the casing 2 of the HVAC system.

The mixing chamber 12 may be disposed between a pair of the external air introduction portions 11 to provide a space for mixing external air introduced from the external air introduction portions 11 and inside air circulated from an interior of the vehicle. The mixing chamber 12 may be formed of a rigid material with sufficient rigidity, for example, metal or plastic, but the material is not limited.

The external air introduction portions 11 may be connected to a front portion and a rear portion of the mixing chamber 12, respectively. Accordingly, when the vehicle moves forward, external air may be introduced from the external air introduction portion 11 connected to the front portion of the mixing chamber 12, and when the vehicle moves rearward, external air may be introduced from the external air introduction portion 11 connected to the rear portion of the mixing chamber 12.

However, introduction of external air is not limited to the above-described example. A portion of external air introduced through one external air introduction portion may be discharged through the other external air introduction portion.

A circulation duct (not illustrated) may be connected to a lower portion of the mixing chamber 12, such that inside air may be introduced into the mixing chamber from the interior of the vehicle. Accordingly, mixed air of external air and inside air may be generated or formed in the mixing chamber 12.

The condenser 13 may be connected to one side of the mixing chamber 12 in the left and right direction. The evaporator 14 may be connected to the other side of the mixing chamber 12 in the left and right direction.

The condenser 13 may cause heat exchange between a refrigerant flowing through the inside of the condenser and mixed air passing through the condenser from the mixing chamber 12, thereby condensing the refrigerant and heating the mixed air. As a result, the HVAC system of the present disclosure may supply warm air into the vehicle interior to perform a heating function, i.e., to heat the interior of the vehicle.

The evaporator 14 may cause heat exchange between a refrigerant flowing through the inside of the evaporator and mixed air passing through the evaporator from the mixing chamber 12, thereby evaporating the refrigerant and absorbing heat from the mixed air to cool the mixed air. As a result, the HVAC system of the present disclosure may supply cool air into the vehicle interior to perform a cooling function, i.e., to cool the interior of the vehicle.

A pair of blowers 15 may be respectively disposed downstream of the condenser 13 and downstream of the evaporator 14. Each blower 15 may intake mixed air from the mixing chamber 12 and discharge the mixed air to the outside of the HVAC system, for example, to the vehicle interior.

Each blower 15 may be configured as an axial fan driven by a motor, but the present disclosure is not limited thereto. Thus, each blower 15 may be configured as a propeller-type fan driven by a motor. In addition, the blowers 15 may be integrated with the condenser 13 or the evaporator 14 and modularized.

Accordingly, in the HVAC system of the present disclosure, each blower 15 may provide an intake function for introducing inside air into the HVAC system, and/or a blowing function for discharging mixed air into the vehicle interior.

Detailed configurations and operational or functional relationships of the above-described condenser 13, evaporator 14, blowers 15, and related components are already well known, and thus detailed descriptions thereof have been omitted herein.

In addition, the HVAC system may include a plurality of air supply portions 16 that are respectively in communication with the blowers 15. For example, a pair of air supply portions 16 may be respectively disposed on both sides of a single blower 15.

Each air supply portion 16 may include a first air supply duct 161, a second air supply duct 162 branched from the first air supply duct, and an air supply door 163 disposed between the first and second air supply ducts, i.e., at a branch point. The branch point is a location or position where the second air supply duct 162 branches off or from the first air supply duct 161.

For example, the first air supply duct 161 may supply warm air and/or cool air to the vehicle interior. A second air supply duct 162 may be configured to discharge inside air to the outside of the vehicle, together with external air introduced when blowing is not required. As a result, ventilation of the vehicle interior may be achieved.

In this case, an angle of the air supply door 163 may be adjusted, thereby allowing air to be blown into at least one of the first air supply duct 161 and the second air supply duct 162.

Optionally, the first air supply duct 161 of the blower 15 on a side of the condenser 13 and the first air supply duct 161 of the blower 15 on a side of the evaporator 14 may be connected to and integrated with each other.

One of warm air from the blower 15 on the side of the condenser 13, cool air from the blower 15 on the side of the evaporator 14, or mixed warm/cool air of warm air from the blower on the side of the condenser and cool air from the blower 15 on the side of the evaporator may be supplied to the integrated first air supply duct 161. Accordingly, the HVAC system may more easily control a temperature of the vehicle interior.

In addition, the air supply portions 16 may include a tubular or annular sidewall member 164 connecting ends of a plurality of second air supply ducts 162 to each other. Here, an end of the second air supply duct 162 may be positioned on a side opposite to the branch point with the first air supply duct 161 in a longitudinal direction of the second air supply duct, and an opening may be formed at the end.

The sidewall member 164 may include a plurality of through-holes 165 formed at an interval in a circumferential direction of the sidewall member. The through-holes 165 may be disposed to be respectively in communication with the openings of the corresponding second air supply ducts 162.

The casing 2 may be formed and disposed to surround the system body 1. In other words, the casing may be formed to accommodate and protect the above-described components, i.e., the external air introduction portion 11, the mixing chamber 12, the condenser 13, the evaporator 14, the blower 15, and the air supply portions 16.

For example, the casing 2 may at least partially have a dome shape. In addition, in plan view, the casing may have a circular or elliptical cross-sectional shape.

Due to the casing 2 having such a shape, the HAVC system according to an example embodiment of the present disclosure may reduce air resistance when mounted on the roof of the vehicle, thereby improving aerodynamic performance of the vehicle.

The casing 2 may be formed of a sufficiently rigid material such as, for example, metal or plastic having rigidity, but the material is not limited.

At least a front surface and a rear surface of the casing 2 may be opened to allow smooth introduction and/or discharge of external air, and may be closed, as necessary.

Specifically, the casing 2 may include a first cover 21, a second cover 22, and a separator 23 disposed between the first cover and the second cover.

The first cover 21 may have a dome shape. In plan view, the first cover 21 may have a circular or elliptical shape.

In addition, the first cover 21 may include a plurality of inlet holes 211 formed on a side surface adjacent to a circumferential edge of the first cover 21. The inlet holes 121 may be arranged at a predetermined interval in a circumferential direction.

The plurality of inlet holes 211 may be formed as holes of a perforated plate, but the present disclosure is not limited thereto, and may be formed, for example, as slit-shaped elongated holes, slots, or the like. As a result, the plurality of inlet holes 211 may function as a type of grill.

The second cover 22 may include a bottom plate 221 having a circular or elliptical shape, in plan view, and a tubular or annular side plate 222 connected to a circumferential edge of the bottom plate 221. The bottom plate 221 and the side plate 222 may be integrally formed, but the present disclosure is not limited thereto.

The bottom plate 221 may include a plurality of air supply holes 223, i.e., openings or apertures, formed to be in communication with the first air supply ducts 161 of the air supply portions 16, and a circulation hole 224, i.e., opening or aperture, for connecting the mixing chamber 12 and the circulation duct to each other.

The side plate 222 may include a plurality of outlet holes 225 formed at an interval in a circumferential direction of the side plate. The outlet holes 225 may be disposed to respectively be in communication with an opening of a second air supply duct 162 and a through-hole 165 of a sidewall member 164.

In the second cover 22, components included in the system body 1 may be installed on the bottom plate 221. A gap may be located between the tubular sidewall member 164 provided in the air supply portion 16 and the side plate 222.

The separator 23 may be formed as a substantially plate-shaped member and interposed between the first cover 21 and the second cover 22. The separator may have a circumferential shape corresponding to the circumferential shapes of the first cover and the second cover.

The separator 23 may separate a space defined by the first cover 21 from a space defined by the second cover 22 from each other but may also allow communication between both spaces. To this end, the separator 23 may include a plurality of communication holes 231, i.e., openings or apertures, formed to pass through the separator in a thickness direction.

Each communication hole 231 may be disposed to correspond to and be adjacent to an inlet 111 of an external air introduction portion 11 accommodated in the second cover 22. Accordingly, external air, introduced into the first cover 21 through the inlet holes 211, may be introduced into the inlet of the external air introduction portion 11 through the communication hole 231 of the separator 23.

The first cover 21 and the second cover 22 may be coupled to each other using a method such as press fitting, screw coupling, or bolting to form the casing 2.

In addition, the bottom plate 221 of the second cover 22 may be fixedly mounted on the roof of the vehicle, such that the casing 2 as well as the HAVC system according to the present disclosure may be mounted on the vehicle roof. To this end, a flange (not illustrated) for bolting may optionally be provided on the bottom plate.

The HAVC system according to an example embodiment of the present disclosure may further include a sliding door 3 installed in the casing 2 to open and close the plurality of outlet holes 225. A driving portion 4 installed may be installed in the casing 2 to drive movement of the sliding door 3.

The sliding door 3 may be formed to have a tubular or annular shape having a substantially circular or elliptical circumferential shape. The sliding door 3 may be positioned in the gap between the sidewall member 164 of the system body 1 and the side plate 222 of the second cover 22 in the casing 2. Accordingly, the sliding door 3 may slidably move to be in contact with an external surface of the sidewall member 164 and/or an internal surface of the side plate 222.

The sliding door 3 may be formed of a flexible material such as rubber or resin, but the present disclosure is not limited thereto.

The sliding door 3 may include a plurality of opening portions 31, 33, 35, and 37 and a plurality of closing portions 32, 34, 36, and 38, alternately formed in a circumferential direction of the sliding door.

For example, a first opening portion 31, a first closing portion 32, a second opening 33, a second closing portion 34, a third opening portion 35, a third closing portion 36, a fourth opening portion 37, and a fourth closing portion 38 may be sequentially disposed on or defined by the sliding door 3 in a first direction (for example, a clockwise direction). The first opening portion 31 may be adjacent the fourth closing portion 38.

The plurality of opening portions 31, 33, 35, and 37 may have an area capable of opening the plurality of outlet holes 225 provided in the second cover 22. The plurality of closing portions 32, 34, 36, and 38 may have an area capable of closing the plurality of outlet holes.

The first to fourth opening portions 31, 33, 35, and 37 may have the same open area. In other words, arcs, forming the opening portions in cross-sectional view, may have the same length.

At least one of the first to fourth closing portions 32, 34, 36, and 38 may have a closed area different from those of the other closing portions. For example, a length of an arc, forming the fourth closing portion 38 in a circumferential direction, may be approximately twice as long as lengths of arcs forming the other closing portions.

In addition, ring-shaped circumferential edge portions 39 may be respectively formed on both sides of the sliding door 3 in a height direction, i.e., upper and lower portions of the sliding door 3.

A rack gear 40 for rotational driving of the sliding door 3 may be arranged and formed on an internal surface of the circumferential edge portion 39 in a movement direction of the sliding door, i.e., in a circumferential direction. The rack gear 40 may engage with a pinion gear 44 of the driving portion 4 to transfer driving force of the driving portion to the sliding door 3.

The driving portion 4 may include an actuator 41 having a motor, a driving shaft 42 rotatably connected to the actuator, and a pinion gear 44 formed on or coupled to both sides of the driving shaft to engage with the rack gear 40 of the sliding door 3. A plurality of driving portions 4 may be provided in the casing.

The actuator 41, having a motor capable of forward and reverse rotation, may be fixedly disposed in the first cover 21.

Optionally, the actuator 41 may be fixed to one side surface of the separator 23 and stably supported by the one side surface of the separator 23. In this case, it should be apparent that the actuator 41 should not interfere with the communication hole 231. An output shaft of the actuator may be directly or indirectly connected to the driving shaft 42 via a power transmission mechanism.

The driving shaft 42 may be positioned radially on the inside of the sidewall member 164 and rotatably installed in the casing 2.

Specifically, one end of the driving shaft 42, such as an upper end, may be rotatably supported by the separator 23, and the other end, such as a lower end, of the driving shaft may be rotatably supported by the bottom plate 221 of the second cover 22. The one end of the driving shaft 42 may pass through the separator and be exposed to the inside of the first cover 21, and the actuator 41 may be connected to the exposed end to rotatably drive the driving shaft.

In addition, the driving shaft 42 may be connected to the sliding door 3 via a rack-and-pinion mechanism to cause the sliding door to slidably and rotationally move.

To allow for the pinion gear 44 of the driving shaft 42, disposed radially on the inside of the sidewall member 164, to engage with the rack gear 40 of the sliding door 3, disposed radially on the outside of the sidewall member, cutout grooves 166 may be formed on both sides of the sidewall member in the height direction. As a result, a portion of the pinion gear 44 may pass through the cut-out groove 166 and may be exposed to the outside of the sidewall member 164. Also, the exposed portion of the pinion gear 44 may engage with the rack gear 40 of the sliding door 3.

When the HAVC system of the present disclosure is horizontally mounted on the roof of a vehicle, the sliding door 3 and the driving shaft 42 may be installed in a substantially upright position. Due to rotation of the driving shaft 42, the sliding door 3 may slidably move around, i.e., rotate in a circumferential direction of the system in the casing 2.

The sliding door 3, configured to slidably move as described above, may move within a range for opening or closing the plurality of outlet holes 225 provided in the second cover 22.

In the HAVC system according to an example embodiment of the present disclosure, the driving portion 4 may further include a power transmission mechanism 43 allowing an adjacent air supply door, among a plurality of air supply doors 163, to be linked to the sliding door 3.

The power transmission mechanism 43 may include a driving gear 45 provided on the driving shaft 42, a driven gear 46 provided on the air supply door 163, and a connection gear 47 interposed between the driving gear and the driven gear to engage with the driving gear and the driven gear.

The driving gear 45 may pass through the separator 23, may be fixedly coupled to one end, i.e., the upper end, of the driving shaft 42 exposed to the inside of the first cover 21, and may rotate together with the driving shaft.

A rotary shaft (not specifically shown) of the air supply door 163, positioned at a branch point between the first air supply duct 161 and the second air supply duct 162, may pass through the separator 23 and extend to the inside of the first cover 21. The driven gear 46 may be fixedly coupled to an extending end of the rotary shaft.

The connection gear 47 may be rotatably installed on one side surface of the separator 23 and positioned to engage with the driving gear 45 and the driven gear 46. Driving force transferred to the actuator 41, the driving shaft 42, and the driving gear 45 may be transferred to the driven gear 46 via the connection gear, thereby allowing the rotary shaft and the air supply door 163 to be rotationally driven.

However, components of the power transmission mechanism 43 are not limited to the above-described example. For example, a belt mechanism connecting a driving wheel and a driven wheel to each other, or a chain mechanism connecting a driving sprocket and a driven sprocket to each other, may be adopted.

In the HVAC system configured as above according to an example embodiment of the present disclosure, external air may be introduced through the inlet holes 211 of the first cover 21 during travel of the vehicle. Subsequently, the external air may be smoothly introduced into the inlet 111 of an external air introduction portion 11 through the communication hole or holes 231 of the separator 23.

In this case, due to the casing 2 having a streamlined structure, the HVAC system according to an example embodiment of the present disclosure may reduce air resistance, thereby improve the aerodynamic performance of the vehicle.

In addition, the sliding door 3, capable of opening and closing the outlet hole or holes 225 of the second cover 22, may allow unnecessary air to be selectively discharged while preventing external air from being introduced through the outlet hole.

In addition, an opening portion of the second air supply duct 162, forming the system body 1, may be in direct communication with the outlet hole or holes 225 of the second cover 22, forming the casing 2, to reduce a length of the second air supply duct, thereby minimizing sizes of the system body and the HVAC system compared to those according to the related art.

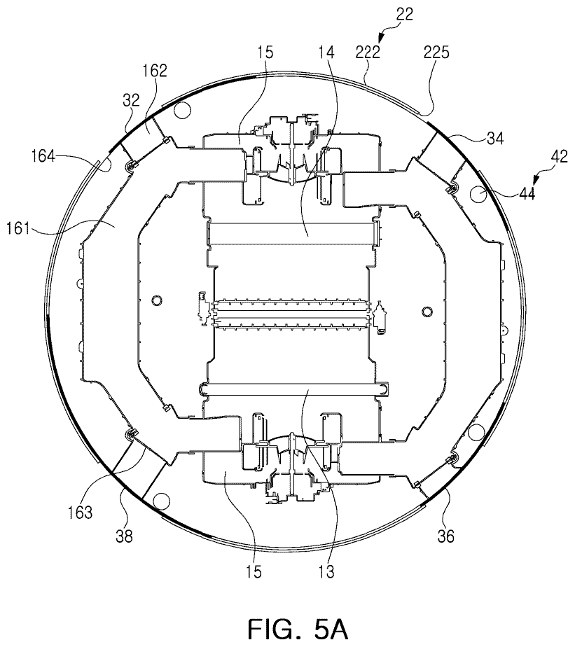

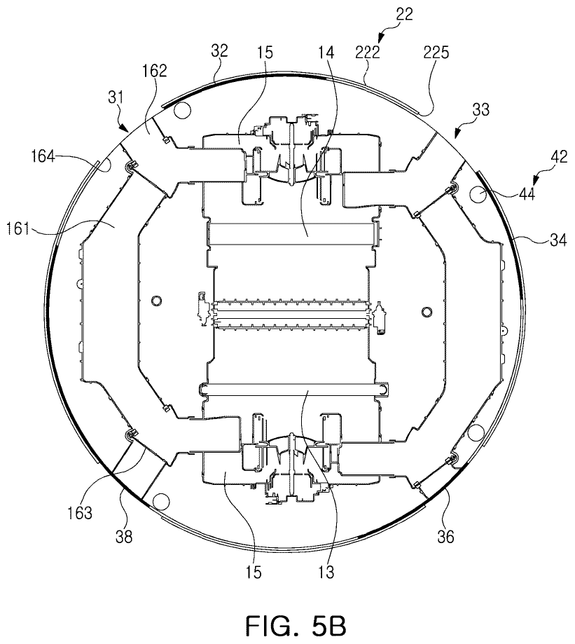

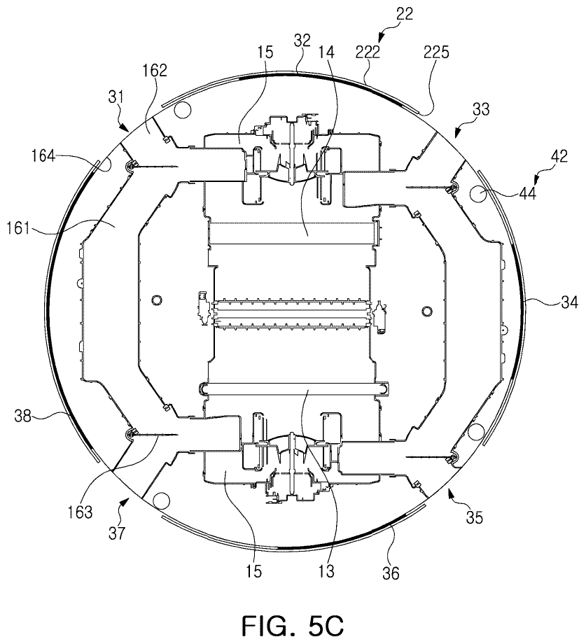

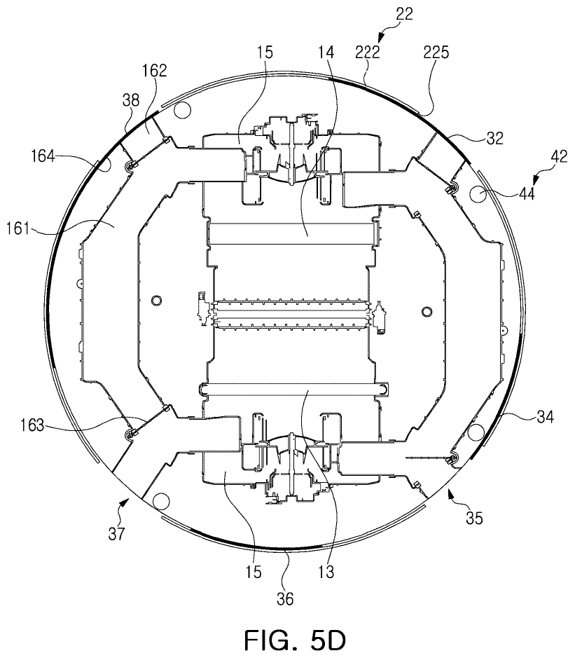

FIGS. 5A-5D illustrate opening and closing of a sliding door according to an operating mode of an HVAC system.

FIG. 5A illustrates a closed mode of the HVAC system. In the closed mode, no air may be discharged through the outlet holes 225, and introduction of external air through the outlet holes may be blocked.

The sliding door 3 may be positioned such that the plurality of closing portions 32, 34, 36, and 38 of the sliding door close the plurality of outlet holes 225 of the second cover 22. The sliding door may be positioned such that at least the plurality of closing portions of the sliding door respectively close the plurality of through-holes 165 of the sidewall member 164.

In addition, the plurality of air supply doors 163, linked to the sliding door 3, may close the opening of the second air supply ducts 162, respectively. As a result, all of the first air supply ducts 161 may be opened, allowing introduction of external air or circulation of inside air.

FIG. 5B illustrates a heating mode of the HVAC system. In the heating mode, air cooled by the evaporator 14 may be discharged through the outlet hole 225 relatively adjacent to the evaporator, and discharge of air heated by the condenser 13 through that outlet hole 225 may be blocked.

To this end, the sliding door 3 may slidably move in a first rotational or circumferential direction (for example, a clockwise direction) from the position illustrated in FIG. 5A due to the plurality of driving portions 4.

In this case, the first closing portion 32 and the second closing portion 34 of the sliding door 3 may move in the first direction and may be displaced from positions of the outlet holes 225, thus uncovering the respective outlet holes. Instead, the first opening portion 31 and second opening portion 33 of the sliding door may be positioned to correspond to those outlet holes, respectively.

In addition, the third closing portion 36 and fourth closing portion 38 of the sliding door may also move in the first direction. However, a portion of the third closing portion and a portion of the fourth closing portion may remain in positions corresponding to those of the corresponding outlet holes 225, thus still covering portions of those outlet holes. As a result, the portion of the third closing portion 36 and the portion of the fourth closing portion 38 of the sliding door may close the corresponding through-holes 165 of the sidewall member 164.

Such an action may be achieved by forming a closed area of at least one of the closing portions, for example, the fourth closing portion 38, wider than those of the other closing portions.

As a result, in the heating mode, the outlet hole 225 relatively adjacent to the evaporator 14 may be opened, and the outlet hole relatively adjacent to the condenser 13 may be closed.

A portion of the plurality of air supply doors 163, linked to movement of the sliding door 3, may open an opening of the second air supply duct or ducts 162 on the side of the evaporator 14, and the other air supply doors 163 may close an opening of the second air supply duct or ducts on the side of the condenser 13.

In other words, the first air supply ducts 161 on the side of the evaporator 14 may be closed, and the first air supply ducts on the side of the condenser 13 may be opened.

The condenser 13 may heat mixed air while condensing a refrigerant flowing in the condenser. As a result, the HVAC system may supply warm air into the vehicle interior to perform a heating function in the heating mode. Conversely, mixed air cooled by passing through the evaporator 14 may be discharged to the outside of the HVAC system, i.e., to external air.

The sliding door 3 may slidably move in a reverse direction, i.e., a second rotational or circumferential direction (for example, a counterclockwise direction), due to the plurality of driving portions 4, and may be placed in the position illustrated in FIG. 5A.

FIG. 5C illustrates a mixing mode of the HVAC system. In the mixing mode, air may be discharged through the outlet holes 225.

To this end, the sliding door 3 may further slidably move, for example, in a first rotational or circumferential direction from the position illustrated in FIG. 5B due to the plurality of driving portions 4.

In this case, the sliding door 3 may be positioned such that the plurality of opening portions 31, 33, 35, and 37 of the sliding door 3 open the plurality of outlet holes 225 of the second cover 22. The sliding door 3 may be positioned such that at least the plurality of opening portions 31, 33, 35, and 37 of the sliding door 3 respectively open the plurality of through-holes 165 of the sidewall member 164.

In addition, the plurality of air supply doors 163, linked to the sliding door 3, may partially open the openings of the second air supply ducts 162, respectively. In other words, the plurality of air supply doors 163 may partially close the openings of the respective second air supply ducts, respectively.

As a result, all of the first air supply ducts 161 may be partially opened, and mixed air of warm air from the condenser 13 and cool air from the evaporator 14 may be supplied to the vehicle interior.

The sliding door 3 may slidably move in a reverse direction, i.e., a second rotational or circumferential direction due to the plurality of driving portions 4 and may be placed in the position illustrated in FIG. 5B.

FIG. 5D illustrates a cooling mode of the HVAC system. In the cooling mode, air heated by the condenser 13 may be discharged through the outlet holes 225 relatively adjacent to the condenser, and discharge of air cooled by the evaporator 14 through the corresponding outlet holes 225 may be blocked.

To this end, the sliding door 3 may further slidably move, for example, in a first rotational or circumferential direction from the position illustrated in FIG. 5C due to the plurality of driving portions 4.

In this case, the second closing portion 34 and the third closing portion 36 of the sliding door 3 may move in the first direction and may be displaced from positions of the outlet holes 225, thus uncovering those outlet holes. Instead, the third opening portion 35 and fourth opening portion 37 may be placed in positions corresponding to those outlet holes 225, respectively.

In addition, the first closing portion 32 and the fourth closing portion 38 of the sliding door 3 may also move in the first direction, and a portion of the first closing portion and a portion of the fourth closing portion may remain in positions corresponding to those of the corresponding outlet holes 225. As a result, the portion of the first closing portion and the portion of the fourth closing portion of the sliding door may close the corresponding through-holes 165 of the sidewall member 164.

Accordingly, in the cooling mode, the outlet holes 225 relatively adjacent to the condenser 13 may be opened, and the outlet holes relatively adjacent to the evaporator 14 may be closed.

A portion of the plurality of air supply doors 163, linked to movement of the sliding door 3, may open an opening of the second air supply ducts 162 on the side of the condenser 13, and the other air supply doors may close an opening of the second air supply ducts on the side of the evaporator 14.

In other words, the first air supply ducts 161 on the side of the condenser 13 may be closed, and the first air supply ducts on the side of the evaporator 14 may be opened.

The evaporator 14 may cool mixed air by absorbing heat from the mixed air while evaporating a refrigerant flowing in the evaporator. As a result, the HVAC system may supply cool air into the vehicle interior to perform cooling. Conversely, mixed air heated by passing through the condenser 13 may be discharged to the outside of the HVAC system, i.e., to external air.

The sliding door 3 may slidably move in a reverse direction, i.e., a second rotational or circumferential direction due to the plurality of driving portions 4 and may be placed in the position illustrated in FIG. 5C.

As described above, according to example embodiments of the present disclosure, the HVAC system may have a streamlined structure and have a minimized size, thereby reducing air resistance and ultimately improving fuel efficiency or electric efficiency of the vehicle.

While example embodiments have been illustrated and described above, it should be apparent to those of ordinary skill in the art that modifications and variations could be made without departing from the scope of the present disclosure as defined by the appended claims.

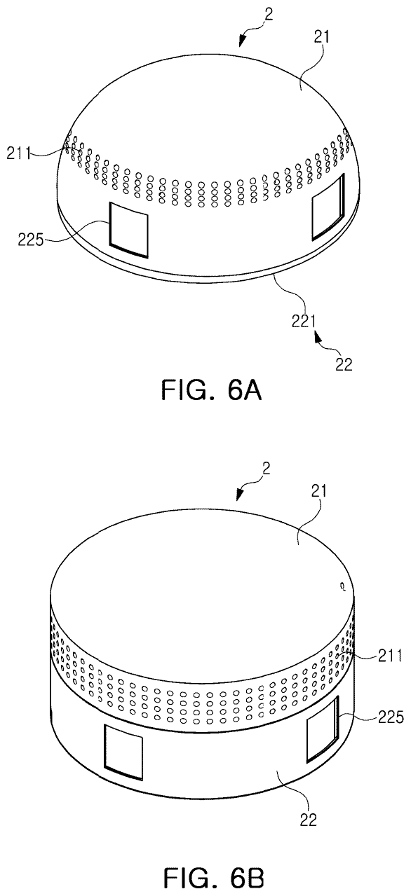

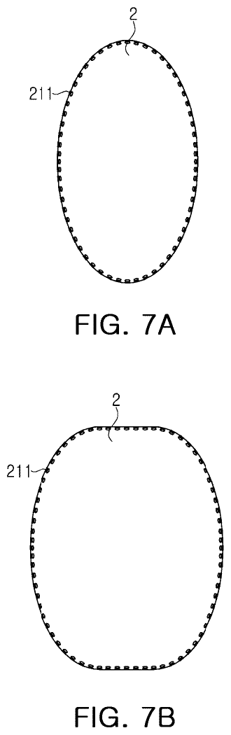

For example, FIGS. 6A-7B are diagrams illustrating other modifications of a casing for the disclosed HVAC systems. As illustrated in FIGS. 6A-7B, a shape of the casing or the like may be changed.

Specifically, an entire casing 2 may have a dome shape (see FIG. 6A) or a cylindrical shape (see FIG. 6B). The shapes may also allow the casing to have a streamlined structure.

When the entire casing 2 has a dome shape, a second cover 22 may include only a bottom plate 221, and a side surface of a first cover 21 may include inlet holes 211 and outlet holes 225. In addition, in this case, a sliding door may be formed of a flexible material, and thus may smoothly and slidably move along a gently curved internal surface of the first cover.

In addition, in plan view, the casing 2 may have an elliptical shape (see FIGS. 7A and 7B). The shape may also allow the casing to have a streamlined structure.

In this case, the sliding door may be formed of a flexible material, and thus may slidably move while elastically responding to a varying curvature of the casing.

The example embodiments described herein are to be considered in a descriptive sense only, and not for purposes of limitation. Therefore, the scope of the present disclosure is defined not by the detailed description, but by the claims and their equivalents. All variations within the scope of the claims and their equivalents are to be construed as being included in the present disclosure.

What is claimed is:

1. A heating, ventilation, and air conditioning (HVAC) system comprising:
a system body at least having a condenser and an evaporator; and
a casing surrounding the system body, the casing having a circular or elliptical circumferential shape,
wherein the casing includes an inlet hole through which external air is introduced and has an outlet hole for discharging air.

2. The HVAC system of claim 1, wherein the casing has at least in part a dome shape.

3. The HVAC system of claim 1, wherein:
the inlet hole includes a plurality of inlet holes; and
the outlet hole includes a plurality of outlet holes provided on a side surface of the casing.

4. The HVAC system of claim 3, further comprising:
a sliding door disposed in the casing to open and close the plurality of outlet holes; and
a driving portion installed in the casing to drive the sliding door.

5. The HVAC system of claim 4, wherein the sliding door includes a plurality of opening portions and a plurality of closing portions, alternately disposed in a circumferential direction of the sliding door.

6. The HVAC system of claim 5, wherein at least one of the plurality of closing portions has a closed area different from those of other of the plurality of closing portions.

7. The HVAC system of claim 4, wherein the sliding door is formed of a flexible material.

8. The HVAC system of claim 1, wherein:
the casing includes a first cover and a second cover;
the first cover includes a plurality of inlet holes arranged at a predetermined interval in a circumferential direction of the first cover;
the second cover includes a bottom plate and a side plate connected to a circumferential edge of the bottom plate; and
the side plate includes a plurality of outlet holes arranged at a predetermined interval.

9. The HVAC system of claim 8, wherein the system body further includes:
a pair of external air introduction portions;
a mixing chamber disposed between the pair of external air introduction portions, the mixing chamber having one portion to which the condenser is connected and another portion to which the evaporator is connected;
a pair of blowers each respectively disposed downstream of the condenser and downstream of the evaporator; and
a plurality of air supply portions connected to the pair of blowers.

10. The HVAC system of claim 9, wherein:
the air supply portion includes
a first air supply duct,
a second air supply duct branched from the first air supply duct, and
an air supply door disposed between the first air supply duct and the second air supply duct; and
an opening of the second air supply duct is in communication with one of the plurality of the outlet holes.

11. The HVAC system of claim 10, wherein:
the air supply portion further includes a sidewall member adjacent to ends of the plurality of the second air supply ducts having the opening; and
the sidewall member includes a plurality of through-holes at a predetermined interval in a circumferential direction of the sidewall member and disposed to be in communication with the opening, respectively, of the plurality of the second air supply ducts.

12. The HVAC system of claim 11, further comprising:
a sliding door disposed in the casing to open and close the plurality of the outlet holes; and
a driving portion installed in the casing to drive the sliding door,
wherein the sliding door includes a plurality of opening portions and a plurality of closing portions alternately disposed and is positioned to move within a gap between the sidewall member and the side plate in the casing.

13. The HVAC system of claim 12, wherein:
the sliding door includes a rack gear formed on an internal surface of a circumferential edge portion of the sliding door; and
the driving portion includes
an actuator,
a driving shaft rotatably connected to the actuator, and
a pinion gear provided on the driving shaft to engage with the rack gear.

14. The HVAC system of claim 13, wherein the sidewall member includes a cutout groove configured and arranged to allow the pinion gear, disposed radially inwardly, to engage with the rack gear, disposed radially outwardly.

15. The HVAC system of claim 13, wherein the driving portion further includes:
a driving gear on the driving shaft;
a driven gear on the air supply door; and
a connection gear interposed between the driving gear and the driven gear and engaging the driving gear and the driven gear.

16. The HVAC system of claim 9, wherein:
the casing includes a separator disposed between the first cover and the second cover;
the separator includes a plurality of communication holes passing through the separator; and
the communication hole is disposed to correspond to an inlet of the external air introduction portion.
